(19) United States
(12) Patent Application Publication
(10) Pub. No.: US 2012/0039159 A1
(43) Pub. Date: Feb. 16, 2012

(54) SPECTRUM AGGREGATION FOR COMMUNICATION USING ROTATION ORTHOGONAL CODING

(75) Inventors: Yuji IKEDA, Saitama (JP); Issei KANNO, Saitama (JP)

(73) Assignee: KDDI CORPORATION, TOKYO (JP)

(21) Appl. No.: 13/206,143

(22) Filed: Aug. 9, 2011

(30) Foreign Application Priority Data
Aug. 11, 2010 (JP) 2010-180445

(51) Int. Cl. H04J 11/00

(52) U.S. Cl. 370/206; 370/203; 370/208

(57) ABSTRACT

A method is disclosed of transmitting a plurality of transmit signals through a plurality of transmit antennas, respectively. The method includes: performing a pre-coding technique in the form of rotation orthogonal coding for a plurality of transmit symbols for a plurality of carriers having respective distinct frequency bands, each of which serves a pre-encoded transmit symbol, to thereby generate a plurality of encoded transmit symbols for the distinct carriers, respectively; and transmitting the generated encoded transmit symbols, through the plurality of transmit antennas, in the transmit signals, respectively, towards a plurality of receive antennas of a receiver through which the transmit signals are received, respectively, to thereby perform spectrum aggregation using the rotation orthogonal coding.

### CROSS-REFERENCE TO RELATED APPLICATIONS

This application claims the priority benefit of Japanese Patent Application No. 2010-180445, filed Aug. 11, 2010, the content of which is incorporated herein by reference in its entirety.

### BACKGROUND OF THE INVENTION

1. Field of the Invention

The invention relates generally to techniques using a transmitter and a receiver capable of spectrum aggregation (or carrier aggregation or frequency aggregation).

2. Description of the Related Art

In recent years, an available communication capacity has been growing with the advancement of wireless communication standards. In particular, International Mobile Telecommunications—Advanced (IMT-Advanced) has a goal of achieving a transmission rate of 1 Gbps while in standing still, and a transmission rate of hundreds of bits per second even while in motion. To achieve this goal, it has been thought that the required frequency bandwidth is on the order of 100 MHz. However, an available frequency resource is decreasing, and we face difficulties in using a continuous broad band at a time.

To ease such difficulties, the spectrum aggregation has been proposed as a technique of transmitting simultaneously a plurality of carrier signals (carrier components) having distinct frequency bands, in combination. In this technique, the simultaneous use of a plurality of channel signals or carrier signals which are distinct in frequency band achieves a virtual broader aggregate frequency band.

As a form of the spectrum aggregation, a technique is known of allocating a plurality of channel signals having respective different transmission characteristics to a user, depending on the user's QoS (Quality of Service) (see, for example, Japanese Patent Application Publication No. 2006-094001). In this technique, depending on the kind of an application program that is executed in the user's equipment, the user's QoS is considered which includes required values of an average transmission speed, delay (e.g., average delay, maximum delay, jitter, etc.), a frame error rate, a transmission power level, a maximum transmission speed, a minimum guaranteed transmission speed, etc. This technique allows an optimal frequency band to be allocated to a user so as to satisfy the user's QoS, which results in more efficient use of a limited frequency resource.

Another technique is known of allocating a frequency resource to a user, such that one of available frequency bands is consecutively selected in the descending order of frequency bands for allocation to the user (see, for example, International Publication No. WO 2006/088082). This technique can increase a number of potential users whom the entire system can accommodate.

The contents of Japanese Patent Application Publication No. 2006-094001 and International Publication No. WO 2006/088082 are incorporated herein by reference in their entirety.

### BRIEF SUMMARY OF THE INVENTION

The above-described conventional techniques are directed to allocation of frequency bands to users, all of which require particular signal processing (e.g., error-correction coding, modulation, demodulation, etc.) to be separately performed for carrier signals having distinct frequency bands.

More specifically, in these convention techniques, although carrier signals having distinct frequency bands are used, these carrier signals are transmitted simultaneously from a transmitter, with these carrier signals not previously combined or mixed in the transmitter.

In contrast, the inventors have conceived, through their study, that it would be desirable to combine a plurality of initial transmit signals having distinct frequency bands, into a plurality of final transmit signals having distinct frequency bands, and to transmit simultaneously these final transmit signals for spreading and multiplex transmission, for the purpose of increasing a frequency diversity gain and transmission quality.

According to a first aspect of the invention, a transmitter for transmitting a plurality of transmit symbols through a plurality of transmit antennas, respectively, is provided.

The transmitter comprises:

an encoder for encoding a transmit bit sequence for a plurality of carriers having respective distinct frequency bands;

a modulator for modulating each of the encoded transmit bit sequences for the distinct carriers, to thereby generate transmit symbols;

a rotation orthogonal encoder configured to perform rotation orthogonal coding for the transmit symbols for the distinct carriers, to thereby generate a plurality of encoded transmit symbols for the distinct carriers, respectively;

a frequency-signal processor configured to perform predetermined frequency-signal processing for the encoded transmit symbol generated for each carrier; and

a transmitting block configured to transmit the plurality of encoded transmit symbols through the plurality of transmit antennas, respectively, towards a plurality of receive antennas of a receiver through which the plurality of encoded transmit symbols are received, respectively,

to thereby perform spectrum aggregation using the rotation orthogonal coding.

According to a second aspect of the invention, a receiver for receiving a plurality of transmit symbols which have undergone rotation orthogonal coding, through a plurality of receive antennas, respectively, is provided.

The receiver comprises:

a receiving block configured to receive the plurality of transmit symbols in the form of a plurality of received signals having respective distinct frequency bands, through the plurality of receive antennas, as a plurality of received symbols, respectively;

a signal-point information detector configured to detect a plurality of signal constellation points for use in restoring the plurality of transmit symbols, based on the plurality of received symbols, a rotation angle θ of the rotation orthogonal coding, and at least one of a channel matrix and a noise matrix; and

a transmit-symbol restorer configured to restore the plurality of transmit symbols, based on the detected signal constellation points,

to thereby perform spectrum aggregation using the rotation orthogonal coding.

According to a third aspect of the invention, a method of transmitting a plurality of transmit symbols through a plurality of transmit antennas, respectively, is provided.

The method comprises:

encoding a transmit bit sequence for a plurality of carriers having respective distinct frequency bands;

modulating each of the encoded transmit bit sequences for the distinct carriers, to thereby generate transmit symbols;

performing rotation orthogonal coding for the transmit symbols for the distinct carriers, to thereby generate a plurality of encoded transmit symbols for the distinct carriers, respectively;

performing predetermined frequency-signal processing for the encoded transmit symbol generated for each carrier signal; and

transmitting the plurality of encoded transmit symbols through the plurality of transmit antennas, respectively, towards a plurality of receive antennas of a receiver through which the plurality of encoded transmit symbols are received, respectively,

to thereby perform spectrum aggregation using the rotation orthogonal coding.

According to a fourth aspect of the invention, a method of receiving a plurality of transmit symbols which have undergone rotation orthogonal coding, through a plurality of receive antennas, respectively, is provided.

The method comprises:

receiving the plurality of transmit symbols in the form of a plurality of received signals having respective distinct frequency bands, through the plurality of receive antennas, as a plurality of received symbols, respectively;

detecting a plurality of signal constellation points for use in restoring the plurality of transmit symbols, based on the plurality of received symbols, a rotation angle θ of the rotation orthogonal coding, and at least one of a channel matrix and a noise matrix; and

restoring the plurality of transmit symbols, based on the detected signal constellation points,

to thereby perform spectrum aggregation using the rotation orthogonal coding.

According to a fifth aspect of the invention, a method of transmitting a plurality of transmit signals through a plurality of transmit antennas, respectively, is provided.

The method comprises:

performing a pre-coding technique in the form of rotation orthogonal coding for a plurality of transmit symbols for a plurality of carriers having respective distinct frequency bands, each of which serves a pre-encoded transmit symbol, to thereby generate a plurality of encoded transmit symbols for the distinct carriers, respectively; and

transmitting the generated encoded transmit symbols, through the plurality of transmit antennas, in the transmit signals, respectively, towards a plurality of receive antennas of a receiver through which the transmit signals are received, respectively,

to thereby perform spectrum aggregation using the rotation orthogonal coding.

It is noted here that, as used in this specification, the singular form “a,” “an,” and “the” include plural reference unless the context clearly dictates otherwise. It is also noted that the terms “comprising,” “including,” and “having” can be used interchangeably.

It is also noted here that the term “transmitter” and the term “receiver” may be each interpreted to take the form of a single unit which transmits or receives a plurality of carrier signals having distinct frequency bands, or a plurality of separate units each of which transmits or receives only one carrier signal or a plurality of carrier signals sharing the same frequency band.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1A is a schematic view conceptually illustrating a communication system in which a multi-antenna transmitter and a multi-antenna receiver are used, both of which are constructed according to a first illustrative embodiment of the present invention;

FIG. 1B is a schematic view conceptually illustrating a communication system in which a combination of two single-antenna transmitters and a multi-antenna receiver are used, all of which are constructed according to a second illustrative embodiment of the present invention;

FIG. 2 is a functional block diagram conceptually illustrating the transmitter according to the first embodiment;

FIG. 3 is a QPSK constellation diagram illustrating a plurality of signal points having rotation angles θ for rotation orthogonal coding;

FIG. 4 is a 16QAM constellation diagram illustrating a plurality of signal points having rotation angles θ for rotation orthogonal coding;

FIG. 5 is a functional block diagram conceptually illustrating the receiver according to the first embodiment;

FIG. 6 is a graph of BER (Bit Error Rate) vs. rotation angle curves for QPSK and 16QAM; and

FIG. 7 is a graph of BER vs. Eb/No curves for different rotation angles θ and coding rates R.

### DETAILED DESCRIPTION OF THE INVENTION

Several presently preferred embodiments of the invention will be described in more detail by reference to the drawings in which like numerals are used to indicate like elements throughout.

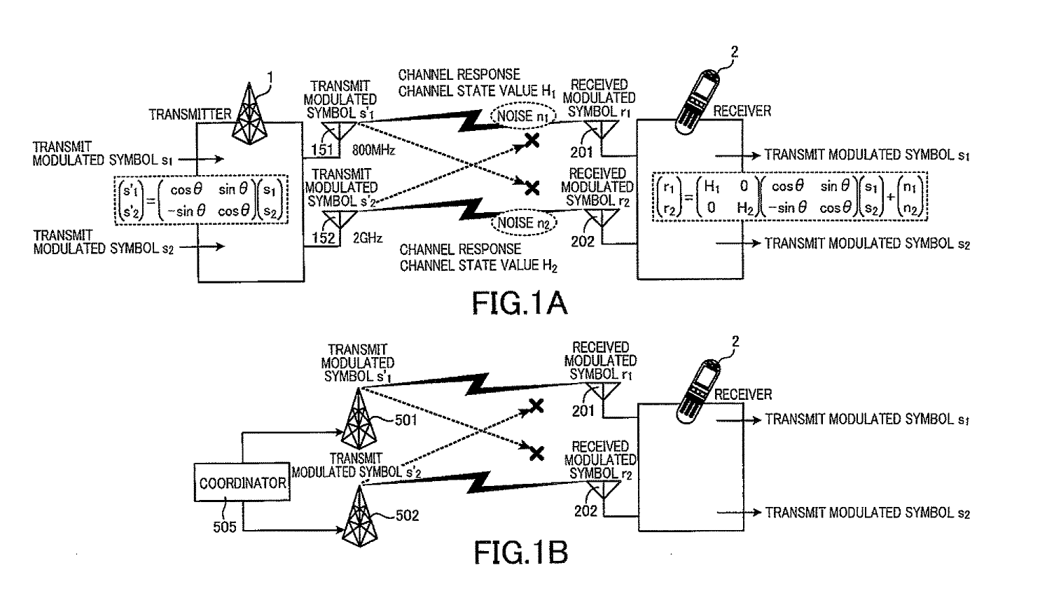

FIG. 1A is a schematic view conceptually illustrating a communication system in which a multi-antenna transmitter 1 and a multi-antenna receiver 2 are used, both of which are constructed according to a first illustrative embodiment of the present invention.

As illustrated in FIG. 1A, the transmitter 1 transmits two (i.e., first and second) non-replicated transmit symbols s₁ and s₂, through first and second transmit antennas 151 and 152, in respective distinct carriers (e.g., an 800 MHz band carrier and a 2 GHz band carrier), respectively.

In response, the receiver 2 receives the first and second transmit symbols s₁ and s₂ through first and second receive antennas 201 and 202, as received symbols r₁ and r₂, respectively, and then, restores the first and second transmit symbols (i.e., original data symbols) s₁ and s₂ from the received symbols r₁ and r₂.

A novel spectrum-aggregation communication scheme is employed in the present embodiment. The novel spectrum-aggregation communication scheme will be briefly described here in comparison with a conventional MIMO (Multiple Input and Multiple Output) method, the novel spectrum-aggregation communication scheme is different from the MIMO method, because the MIMO method is applied such that a plurality of transmit bit sequences are transmitted in the same frequency band, while the novel spectrum-aggregation communication scheme is applied such that a plurality of transmit bit sequences are transmitted in distinct frequency bands.

In the present embodiment, the frequency separation or disagreement between the carriers allows the first transmit symbol that has been transmitted through the first transmit antenna 151 to be received through only the first receive antenna 201 of the receiver 2, as the first received symbol r₁, and at the same time, allows the second transmit symbol s₂ that has been transmitted through the second transmit antenna 152 to be received through only the second receive antenna 202 of the receiver 2, as the second received symbol r₂.

As a result, in the present embodiment, differently from the MIMO method, each of the first and second transmit symbols s₁ and s₂ which has been transmitted through a corresponding one of the transmit antennas 151 and 152 will not be received simultaneously through both of the receive antennas 201 and 202 of the receiver 2.

It is noted that, although the present embodiment will be described for a scenario in which the first transmit symbol s₁ has a frequency band of 800 MHz and the second transmit symbol s₂ has a frequency band of 2 GHz, the selection of these frequency bands are exemplary, and are not exclusive.

As illustrated in FIG. 1A, a single unit of the transmitter (e.g., a base station) 1 transmits a transmit signal simultaneously in both carriers having respective frequency bands of 800 MHz and 2 GHz. In the present embodiment, the transmitter 1 is for use in spectrum-aggregation, and implements a pre-coding technique for performing the spectrum-aggregation.

The pre-coding technique, in general, is applied to an SDM (Space Division Multiplex) transmission scheme or an STC (Space Time Coding) transmission scheme, which are applicable to the MIMO method. Some forms of the pre-coding technique are disclosed in U.S. Patent Application Publication No. US 2004/0218697, the content of which is incorporated herein by reference in its entirety.

For the pre-coding technique to be implemented, reference is made to a code book having a collection of optional patterns that the pre-coding can take, for selecting an optimum pre-coding matrix (or a pre-coding vector) W, and an input signal sequence and an output signal sequence are encoded (each original signal is multiplied by the pre-coding matrix W serving as a weight, to thereby combine each original signal and the pre-coding matrix W together).

The transmitter 1 uses the pre-coding matrix W in the form of a rotation orthogonal coding matrix C. The rotation orthogonal coding matrix C is represented as follows, with θ denoting a rotation angle for the rotation orthogonal coding to be performed:

$$C = ( \begin{matrix}cos θ & sin θ \\ - sin θ & cos θ\end{matrix} ) .$$

The transmitter 1 performs a rotation orthogonal coding operation (i.e., a form of a pre-coding operation) for original data, that is, the first and second transmit symbols s₁ and s₂ (i.e., pre-encoded transmit symbols), to thereby generate first and second encoded transmit symbols s₁′ and s₂′, and then transmits the encoded transmit symbols s₁′ and s₂′ in the respective carriers, through the first and second transmit antennas 151 and 152, respectively. The pre-encoded transmit symbols s₁ and s₂ and the encoded transmit symbols s₁′ and s₂′ that are to be transmitted through the transmit antennas 151 and 152, respectively, have a mathematical relationship represented by the following transmit-symbol equation:

$$( \begin{matrix}{s}_{1}^{′} \\ {s}_{2}^{′}\end{matrix} ) = ( \begin{matrix}cos θ & sin θ \\ - sin θ & cos θ\end{matrix} ) ( \begin{matrix}{s}_{1} \\ {s}_{2}\end{matrix} ) .$$

Using this transmit-symbol equation, the transmitter 1 transforms the first and second transmit symbols s₁ and s₂ into the first and second transmit symbols s₁′ and s₂′ by combining the transmit symbols s₁ and s₂ together. In this regard, anyone of the first and second transmit symbols s₁′ and s₂′ is a combination of a fractional component of the first transmit symbol s₁ and a fractional component of the second transmit symbol s₂.

Upon transmission from the transceiver 1, the first and second transmit symbols s₁′ and s₂′ pass through respective channels (their characteristics, such as channel response or channel state information CSI, are represented by a channel matrix H as described below), and are affected by respective noises (their characteristics are represented by a noise matrix n as described below). That is:

First transmit symbol s₁′ in the 800 MHz band: a channel state value H₁ and a noise state value n₁ in a first channel between the first transmit antenna 151 and the first receive antenna 201; and

Second transmit symbol s₂′ in the 2 GHz band: a channel state value H₂ and a noise state value n₂ in a second channel between the second transmit antenna 152 and the second receive antenna 202.

It is noted that, in the present embodiment, a possible signal propagated over any one of a possible third channel between the first transmit antenna 151 and the second receive antenna 202, and a possible fourth channel between the second transmit antenna 152 and the first receive antenna 201, can be neglected, and corresponding channel state values and noise state values can be both regarded as zero.

The receiver 2 receives the first and second transmit symbols s₁′ and s₂′ through the receive antennas 201 and 202, as the first and second received symbols r₁ and r₂, respectively, which are represented by the following received-symbol equation:

$$( \begin{matrix}{r}_{1} \\ {r}_{2}\end{matrix} ) = ( \begin{matrix}{H}_{1} & 0 \\ 0 & {H}_{2}\end{matrix} ) ( \begin{matrix}cos θ & sin θ \\ - sin θ & cos θ\end{matrix} ) ( \begin{matrix}{s}_{1} \\ {s}_{2}\end{matrix} ) + ( \begin{matrix}{n}_{1} \\ {n}_{2}\end{matrix} ) .$$

It is noted that the channel matrix H is a matrix (e.g., a square matrix) having non-zero elements for the first and second channels, and zero elements for the third and fourth channels.

The receiver 2 performs channel estimation by such as Maximum Likelihood Detection or MMSE (Minimum Mean Square Error)-based equalization, for the first and second received symbols r₁ and r₂, to thereby estimate the channel state information CSI (e.g., the channel matrix H and the noise matrix n).

The receiver 2 further solves the aforementioned received-symbol equation, based on the channel estimation results and a pair of the first and second received symbols r₁ and r₂, to thereby restore the original data, that is, a pair of the first and second transmit symbols s₁ and s₂.

The received-symbol equation will be developed as follows:

r₁=H₁(s₁ cos θ+s₂ sin θ)+n₁, and

r₂=H₂(−s₁ sin θ+s₂ cos θ)+n₂.

In these equations, the first bracketed term of (s₁ cos θ+s₂ sin θ) and the second bracketed term of (−s₁ sin θ+s₂ cos θ), among others, demonstrate that, in each bracketed term, the ratio between the transmit symbols s₁ and s₂ which are added to each other varies depending on the rotation angle θ, with the rotation angle determining the signal constellation.

In a first exemplary scenario in which both the transmit symbols s₁ and s₂ undergo the QPSK (Quadrature Phase Shift Keying), signal points (or constellation points or symbol points on the IQ plane or a complex plane) are defined to have a total number of 16 (=4×4). The constellation of the 16 signal points depends on the rotation angle θ. In a second exemplary scenario in which both the transmit symbols s₁ and s₂ undergo the 16QAM (Quadrature Amplitude Modulation), signal points are defined to have a total number of 256 (=16×16).

In the first scenario, the constellation of the 16 signal points determined by the rotation angle θ is kept unchanged despite any possible changes in the channel state values H₁ and H₂. An optimum value of the rotation angle θ is favorably predetermined such that the signal points are substantially uniformly spaced apart on the IQ plane or a two dimensional signal constellation diagram,

One example of the rotation orthogonal coding technique to be performed, although not for a plurality of transmit symbols like in the present embodiment, but for a plurality of sub-carriers is disclosed in U.S. patent application Ser. No. 12/148,084 (Patent Application Publication No. US 2008/0225927) entitled “TRANSMISSION METHOD” filed Apr. 15, 2008, which is assigned to the assignee hereof and hereby expressly incorporated by reference herein in its entirety.

It is noted that, in the present embodiment, the rotation angle θ is selected for the transmitter 1 and other likewise transmitters, individually and previously, but, in an alternative, for each communication session between the transmitter 1 and the receiver 2, the receiver 2 estimates the channel state information CSI and, based on the channel state information CSI, selects an optimum value of the rotation angle θ so as to reflect an actual phase difference between the transmit symbols s₁ and s₂ and the received symbols r₁ and r₂.

FIG. 1B is a schematic view conceptually illustrating a communication system in which a combination of first and second single-antenna transmitters 501 and 502 which are located at first and second base stations, respectively, and the receiver 2 are used, all of which are constructed according to a second illustrative embodiment of the present invention.

The present embodiment is similar with the first embodiment, except that the transmitters 501 and 502 in the present embodiment are provided for respective carriers, cooperating to serve as the transmitter 1 in the first embodiment.

More specifically, in the present embodiment, the first transmitter (i.e., the first base station) 501 for 800 MHz band transmission, and the second transmitter (i.e., the second base station) 502 for 2 MHz band transmission are separately and remotely located.

The receiver 2 receives the first transmit symbol s₁′ from the first transmitter 501, and the second transmit symbol s₂′ from the second transmitter 502.

Despite the physical separation between the first and second transmitters 501 and 502, the first and second transmit symbols s₁′ and s₂′ are required to have a desired mutual relationship, that is, the same relationship as that in the first embodiment. To this end, in the present embodiment, a coordinator 505 is added which is configured to coordinate the first and second transmitters 501 and 502 to optimize the relationship between the first and second transmit symbols s₁′ and s₂′.

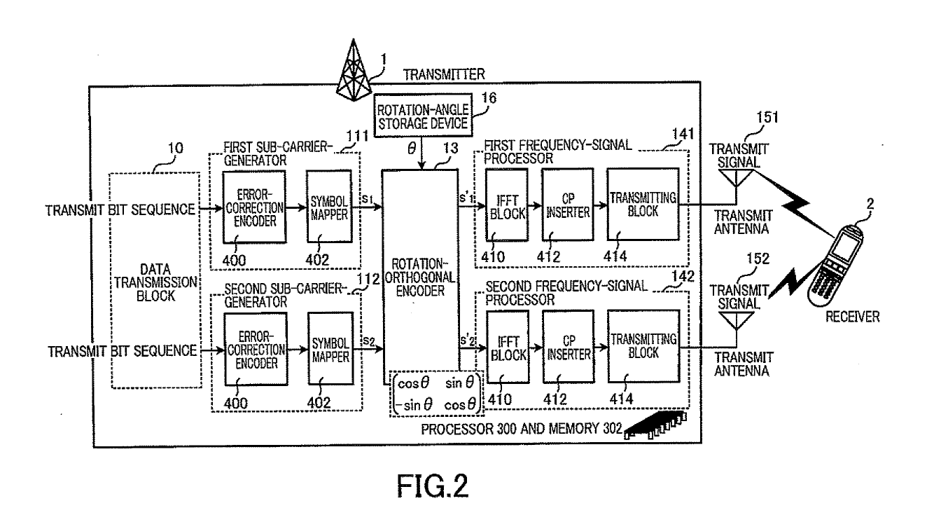

FIG. 2 is a functional block diagram conceptually illustrating the transmitter 1 according to the first embodiment.

The transmitter 1 adopts the OFDM (Orthogonal Frequency Division Multiplexing) transmission scheme to divide each carrier into a plurality of sub-carriers. Further, the transmitter 1 is configured to transmit simultaneously a plurality of carriers having respective distinct frequency bands, through the transmit antennas 151 and 152, for performing the spectrum aggregation. The transmitter 1 is favorably applied to an LTE (Long-Term Evolution)-Advanced base station.

As illustrated in FIG. 2, the transmitter 1 is configured to have a data transmission block 10; first and second sub-carrier generators 111 and 112; a rotation-orthogonal encoder 13; first and second frequency-signal-processors 141 and 142; the transmit antennas 151 and 152; and a rotation-angle storage device 16. These components excepting the transmit antennas 151 and 152 are implemented by operating a processor 300 (e.g., a DSP (Digital Signal Processor), an FPGA (Field Programmable Gate Array), etc.) to execute a predetermined computer program (not shown) using a memory 302. It is noted that the sub-carrier generators 111 and 112 and the frequency-signal processors 141 and 142 are provided on a per-carrier basis, while the rotation-orthogonal encoder 13 is provided in common to the plurality of carriers. The sub-carrier generators 111 and 112 and the frequency-signal processors 141 and 142 each share the fundamental construction, and redundant description will be omitted for them below.

Each sub-carrier generator 111, 112 is configured, per each carrier, to modulate a corresponding one of transmit bit sequences into symbols, and then, to divide each carrier into a plurality of sub-carriers.

To this end, each sub-carrier generator 111, 112, as illustrated in FIG. 2, is configured to have an error-correction encoder 900, and a symbol mapper (or a constellation mapper) 402.

The error-correction encoder 400 of each sub-carrier generator 111, 112 is configured to perform an error-correction encoding operation for the transmit bit sequences to be transmitted, and then to add one or more CRC (Cyclic Redundancy Check) bits to the transmit bit sequences.

The symbol mapper 402 of each sub-carrier generator 111, 112 is configured to map the transmit bit sequence for each carrier to a plurality of signal points (or signal constellation points, symbols) in a two dimensional symbol constellation, to thereby generate the transmit symbol s₁ or s₂ on a per-carrier basis. The symbols of the two dimensional signal constellation represent, on the complex plane (or the IQ plane), the possible modulations of a signal created by modifying its amplitudes and/or phase.

It is noted that, in the first embodiment illustrated in FIG. 2, the sub-carrier generators 111 and 112 are provided on a per-carrier basis, but in an alternative, a single unit of such a sub-carrier generator is provided in common to a plurality of carriers, which can simplify the system design with ease. The relevant feature of the transmitter 1 lies in the rotation-orthogonal encoder 13 as described below.

The rotation-orthogonal encoder 13 is configured to perform a rotation orthogonal coding operation for the transmit symbols s₁ and s₂ for the respective carriers, using the above-described transmit-symbol equation, to thereby generate the first and second transmit symbols s₁′ and s₂′. The rotation-orthogonal encoder 13 performs the rotation orthogonal coding operation for the symbols, using the rotation angle θ which is predetermined to be suitable to a pre-selected modulation scheme for the symbols.

The rotation orthogonal encoder 13 is configured to perform, when the carrier number N (i.e., the total number of carriers used, or a spreading rate)=2, the rotation orthogonal coding by a pre-coding technique using the following rotation orthogonal coding matrix C:

$$C = ( \begin{matrix}cos θ & sin θ \\ - sin θ & cos θ\end{matrix} ) .$$

In the present embodiment, the rotation orthogonal encoder 13 performs the rotation orthogonal coding when the carrier number N=2, but in some alternatives, the rotation orthogonal encoder 13 is modified to perform the rotation orthogonal coding when the carrier number N is larger than 2.

In one alternative where the carrier number N=2ⁿ (n: integer equal to or more than two), the rotation orthogonal encoder 13 is modified to perform the rotation orthogonal coding using the following rotation orthogonal coding matrix C₂_{ⁿ}:

$${C}_{{2}^{″}} = ( \begin{matrix}{C}_{{2}^{n - 1}} cos {θ}_{n} & {C}_{{2}^{n - 1}} sin {θ}_{n} \\ - {C}_{{2}^{n - 1}} sin {θ}_{n} & {C}_{{2}^{n - 1}} cos {θ}_{n}\end{matrix} ) ,$$

where,

θₙ: rotation angle for the rotation orthogonal coding, and

C₂_{¹}: 1.

In another alternative where the carrier number N=2²=4 (n=2), the rotation orthogonal encoder 13 is modified to perform the rotation orthogonal coding the following rotation orthogonal coding matrix C₄:

$$\begin{matrix}{C}_{4} = ( \begin{matrix}{C}_{2} cos {θ}_{2} & {C}_{2} sin {θ}_{2} \\ - {C}_{2} sin {θ}_{2} & {C}_{2} cos {θ}_{2}\end{matrix} ) \\ = ( \begin{matrix}cos {θ}_{1} cos {θ}_{2} & sin {θ}_{1} cos {θ}_{2} & cos {θ}_{1} sin {θ}_{2} & sin {θ}_{1} sin {θ}_{2} \\ - sin {θ}_{1} cos {θ}_{2} & cos {θ}_{1} cos {θ}_{2} & - sin {θ}_{1} sin {θ}_{2} & cos {θ}_{1} sin {θ}_{2} \\ - cos {θ}_{1} sin {θ}_{2} & - sin {θ}_{1} sin {θ}_{2} & cos {θ}_{1} cos {θ}_{2} & sin {θ}_{1} cos {θ}_{2} \\ sin {θ}_{1} sin {θ}_{2} & - cos {θ}_{1} sin {θ}_{2} & - sin {θ}_{1} cos {θ}_{2} & cos {θ}_{1} cos {θ}_{2}\end{matrix} )\end{matrix}$$

where,

θ₁, θ₂: rotation angles for the rotation orthogonal coding.

In still another alternative where the carrier number N is not equal to any one of 2ⁿ or any one of the powers of “2,” the invention is also applicable. In an example where the carrier number N=3, the rotation orthogonal encoder 13 is modified to perform the rotation orthogonal coding using the following rotation orthogonal coding matrix C₃:

$${C}_{3} = ( \begin{matrix}cos {θ}_{1} cos {θ}_{3} - sin {θ}_{1} sin {θ}_{2} sin {θ}_{3} & cos {θ}_{2} sin {θ}_{1} & cos {θ}_{3} sin {θ}_{1} sin {θ}_{2} + cos {θ}_{2} sin {θ}_{3} \\ - cos {θ}_{3} sin {θ}_{1} - cos {θ}_{1} sin {θ}_{2} sin {θ}_{3} & cos {θ}_{1} cos {θ}_{2} & cos {θ}_{1} cos {θ}_{3} sin {θ}_{2} - sin {θ}_{1} sin {θ}_{3} \\ - cos {θ}_{2} sin {θ}_{3} & - sin {θ}_{2} & cos {θ}_{2} cos {θ}_{3}\end{matrix} ) ,$$

where,

θ₁, θ₂, θ₃: rotation angles for the rotation orthogonal coding.

The rotation-orthogonal encoder 13 forwards the first and second transmit symbols s₁′ and s₂′ upon rotation orthogonal coding to a resource-block mapping section configured to map the symbols to a resource block. The resource-block mapping section delivers the resource block to the first and second frequency-signal processor 141 and 142.

Each frequency-signal processor 141, 142 is configured to perform a predetermined frequency-signal processing operation (e.g., transformation from waves in frequency domain to waves in time domain) for a corresponding one of the first and second transmit symbols s₁′ and s₂′, and then, to forward the processed corresponding transmit symbol s₁′ or s₂′ to each transmit antenna 151, 152.

To this end, each frequency-signal processor 141, 142, as illustrated in FIG. 2, is configured to have an IFFT (Inverse Fast Fourier Transform) block 410; a CP (Cyclic Prefix) inserter 412; and a transmitting block 414.

The IFFT block 410 of each frequency-signal processor 141, 142 is configured to transform a corresponding one of the first and second transmit symbols S₁′ and s₂′ which have undergone the rotation orthogonal coding, from waves in frequency domain to waves in time domain. The IFFT block 410 combines the plurality of sub-carriers into a transmit signal for each carrier in the form of a multi-carrier wave signal (i.e., the corresponding transmit symbol s₁′ or s₂′). As well known, each IFFT block 410 includes a parallel-serial converter and a serial-to-parallel, converter.

Upon completion of the IFFT, the IFFT block 410 of each frequency-signal processor 141, 142 forwards the corresponding transmit symbol s₁′ or s₂/to the corresponding CP inserter 412.

The CP inserter 412 of each frequency-signal processor 141, 142 is configured to insert CPs (Cyclic Prefixes) to the transmit signals for the respective carriers, to preserve orthogonality between sub-carriers in a multi-path environment in which a multi-path delay is smaller than a CP time guard interval, to achieve robustness against multi-path delay propagation. The CP inserter 412 forwards the corresponding transmit signal into which the CPs have been inserted, to the corresponding transmitting block 414.

The transmitting block 414 of each frequency-signal processor 141, 142 is configured to forward the corresponding transmit signal, which has been received from the corresponding CP inserter 412, to the corresponding transmit antenna 151 or 152.

The rotation-angle storage device 16 has previously stored therein the rotation angle θ for the rotation orthogonal coding to be performed by the rotation-orthogonal encoder 13. The rotation angle θ has been selected as an optimal value suitable to a modulation scheme pre-selected for the symbols (e.g., QPSK, 16QAM).

More specifically, the rotation angle θ is selected such that signal constellation points for a modulation method that the transmitter 1 uses are substantially uniformly spaced apart.

Still more specifically, in the present embodiment in which the carrier number N=2, the rotation angle θ is selected such that, if the transmitter 1 uses the QPSK, θ=tan⁻¹½, and, if the transmitter 1 uses the 16QAM, θ=tan⁻¹¼.

In an alternative wherein the carrier number N=4, the rotation angles θ₁ and θ₂ described above are selected such that, if the transmitter 1 uses the QPSK, θ₁=tan⁻¹¼ and θ₂=tan⁻¹½, and, if the transmitter 1 uses the 16QAM, θ₁=tan⁻¹ 1/16 and θ₂=tan⁻¹¼.

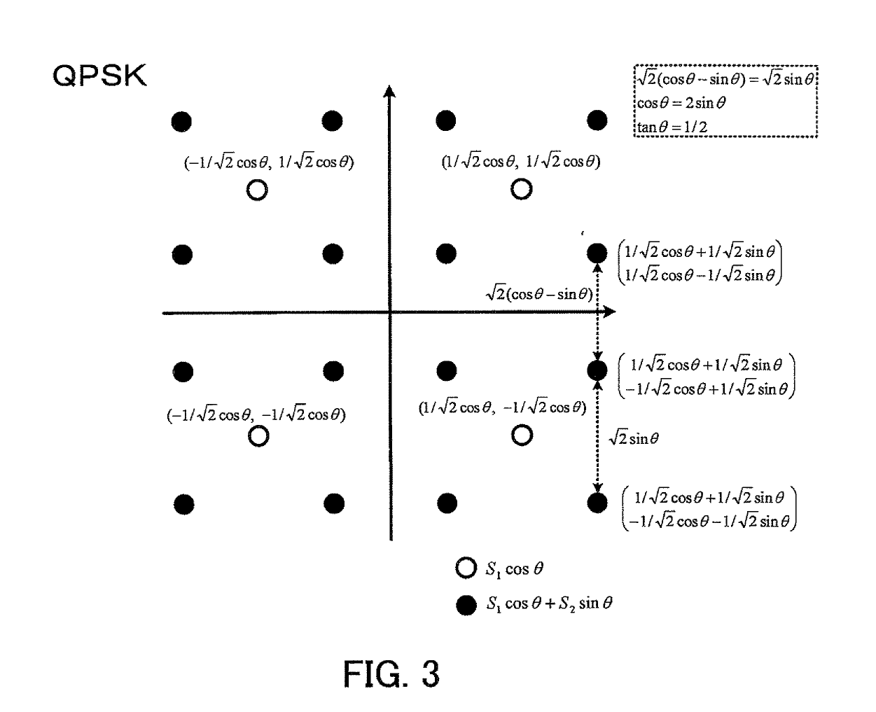

FIG. 3 is a two dimensional signal constellation diagram plotting a plurality of signal points having the rotation angles θ for the rotation orthogonal coding when the QPSK is adopted.

As illustrated in FIG. 3, when the transmitter 1 uses the QPSK, the signal points are denoted by the following:

o: s₁ cos θ; and

: s₁ cos θ+s₂ sin θ.

For minimizing possible error in detecting symbols (i.e., signal points), it is preferable to select the signal points so as to be substantially uniformly spaced apart on the IQ plane, and, as a result, to select the rotation angles 8 as follows:

\sqrt{2}(cos θ−sin θ)=\sqrt{2} sin θ→θ=tan⁻¹½.

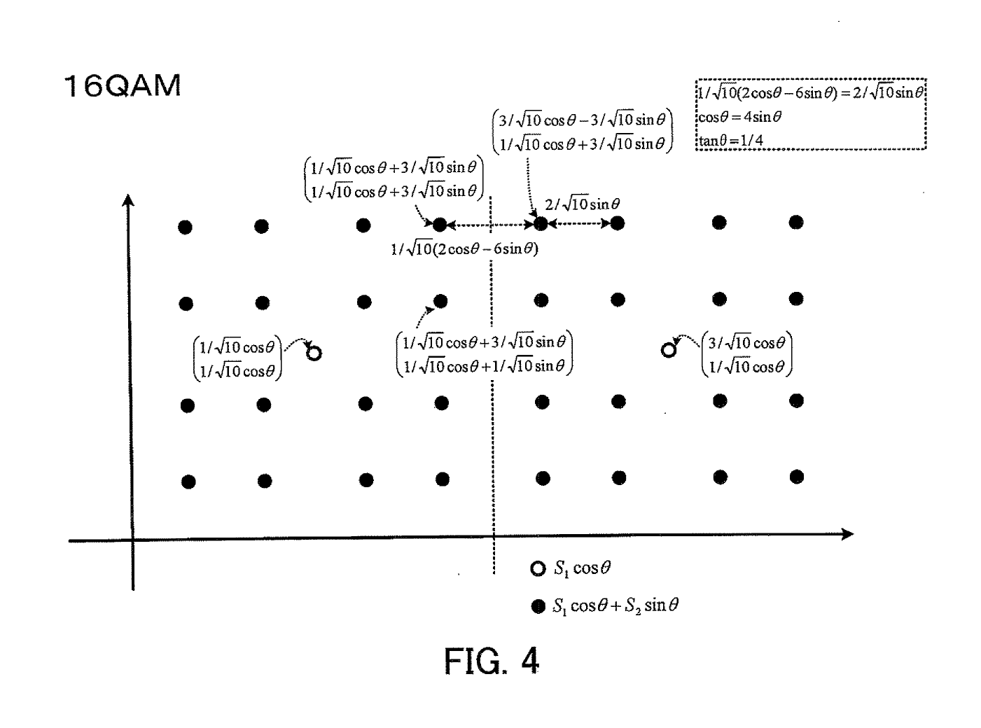

FIG. 4 is a two dimensional signal constellation diagram plotting a plurality of signal points having the rotation angles θ for the rotation orthogonal coding when the 16QAM is adopted.

When the transmitter 1 uses the 16QAM, it is preferable to select the signal points so as to be substantially uniformly spaced apart on the IQ plane, and, as a result, to select the rotation angles θ as follows:

1/\sqrt{10}(2 cos θ−6 sin θ)=2/\sqrt{10} sin θ→θ=tan⁻¹¼.

It is added that the present embodiment can be practiced when the transmitter 1 uses an alternative multi-level digital modulation scheme.

In the present embodiment, the first and second transmit symbols s₁ and s₂ are modulated in the same scheme, but in an alternative, the first and second transmit symbols s₁ and s₂ can be modulated in different schemes. In an example of the alternative, the first transmit symbol s₁ is modulated by the QPSK, while the second transmit symbols s₂ is modulated by the 16QAM. In this example, the rotation angle θ is preferably selected so that 64 (=4×16) signal points can be substantially uniformly spaced apart.

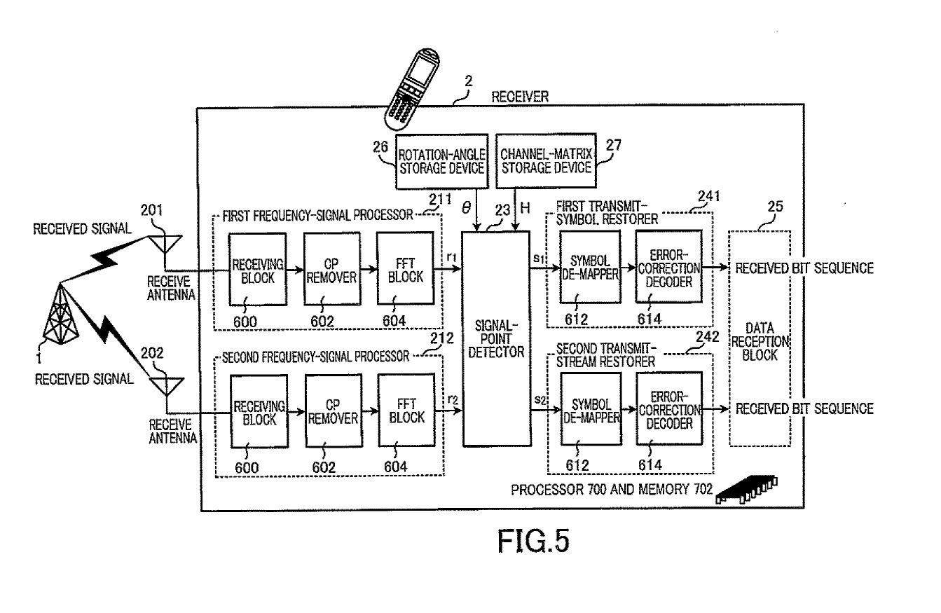

FIG. 5 is a functional block diagram illustrating conceptually the receiver 2 according to the first embodiment.

As illustrated in FIG. 5, the receiver 2 is designed to be able to communicate with the transceiver 1 depicted in FIG. 1A or the transceivers 501 and 502 depicted in FIG. 1B, and to perform spectrum aggregation by simultaneous reception through a plurality of receive antennas 201 and 202, of a plurality of carriers having distinct frequency bands which have been transmitted from the transceiver 1 or the transceivers 501 and 502.

The receiver 2 is configured to have the first and second receive antennas 201 and 202; first and second frequency-signal processors 211 and 212; a signal-point detector 23; first and second transmit-symbol restorers 291 and 242; a data receiving block 25; a rotation-angle storage device 26; and a channel-matrix storage device 27. These components excepting the receive antennas 201 and 202 are implemented by operating a processor 700 (e.g., a DSP (Digital Signal Processor), an FPGA (Field Programmable Gate Array), etc.) to execute a predetermined computer program (not shown) using a memory 702.

The rotation-angle storage device 26 has stored therein the same rotation angle θ as that stored in the rotation-angle storage device 16 of the transmitter 1.

It is noted that the frequency-signal processors 211 and 212 and the transmit-symbol restorers 241 and 242 are provided on a per-carrier basis, while the signal-point detector 23 is provided in common to the plurality of carriers. The frequency-signal processors 211 and 212 and the transmit-symbol restorers 241 and 242 each share the fundamental construction, and redundant description will be omitted for them below.

Each frequency-signal processor 211, 212 is configured to perform a predetermined frequency-signal processing operation (e.g., transformation from waves in time domain to waves in frequency domain) for a corresponding one of the received signals, which is for a corresponding one of the first and second transmit symbols and s₂′, to thereby transform the received signals carrier into a plurality of received symbols.

To this end, each frequency-signal processor 211, 212, as illustrated in FIG. 5, is configured to have a receiving block 600; a CP (Cyclic Prefix) remover 602; and an FFT (Fast Fourier Transform) block 604.

The receiving block 600 of each frequency-signal processor 211, 212 forwards a corresponding one of the first and second received symbols r₁ and r₂ which have been outputted from the corresponding receive antenna 201, 202, to the corresponding CP remover 602.

The CP remover 602 of each frequency-signal processor 211, 212 removes CPs (Cyclic Prefixes) from the corresponding received signal, and then forwards the corresponding received signal to the corresponding FFT block 604.

The FFT block 604 of each frequency-signal processor 211, 212 transforms the corresponding received signal from waves in time domain into waves in frequency domain. The FFT block 604 extracts a plurality of symbols from a signal which has been received on a per-carrier basis in the form of a multi-carrier wave, and then forwards the extracted symbols to the signal-point detector 23, as the received symbols r₁ and r₂. As well known, each FFT block 604 includes a parallel-serial converter and a serial-to-parallel converter.

The signal-point detector 23 performs channel estimation by such as Maximum Likelihood Detection or MMSE (Minimum Mean Square Error)-based equalization, to thereby estimate the channel matrix H and the noise matrix n, and to store the estimation results in the channel-matrix storage device 27.

The signal-point detector 23 further solves the aforementioned received-symbol equation, based on the estimated channel matrix H and noise matrix n, the rotation angle θ stored in the rotation-angle storage device 26, and the received symbols r₁ and r₂ which have been received for respective carriers, to thereby detect a first set of signal points (e.g., information on the I value and the Q value of each signal point) necessary for restoring the first transmit symbol s₁, and a second set of signal points (e.g., information on the I value and the Q value of each signal point) necessary for restoring the second transmit symbol s₂.

The signal-point detector 23 still further forwards the first set of signal points to the first transmit-symbol restorer 241, and the second set of signal points to the second transmit-symbol restorer 242.

Each transmit-symbol restorer 241, 242 restores a corresponding one of the first and second transmit symbols s₁ and s₂, based on the received symbols r₁ and r₂ received from the signal-point detector 23, on a per-carrier basis.

To this end, each transmit-symbol restorer 241, 242 is configured to have a symbol demapper (constellation demapper) 612; and an error-correction decoder 614.

The symbol demapper 612 of each transmit-symbol restorer 241, 242 demaps a corresponding one of the first and second sets of signal points (i.e., symbols), and then the error-correction decoder 614 of each transmit-symbol restorer 241, 242 performs error-correction decoding, and performs demodulation-error detection, based on the CRC check bits.

The error-correction decoders 614 and 614 of the first and second transmit-symbol restorers 241 and 242 forwards the processed transmit symbols s₁ and s₂ to the reception block 25.

It is noted that, in the first embodiment illustrated in FIG. 5, the transmit-symbols restorers 241 and 242 are provided on a per-carrier basis, but in an alternative, a single unit of such a transmit-symbol restorer is provided in common to a plurality of carriers, which can facilitate simplified system design. The relevant feature of the receiver 2 lies in the signal-point detector 23.

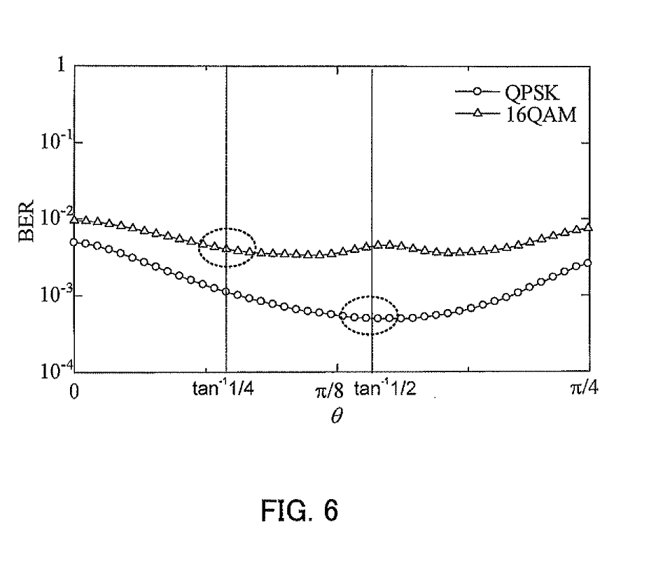

FIG. 6 is a graph of examples of BER (Bit Error Rate) vs. rotation angle curves for QPSK and 16QAM.

Each curve in FIG. 6 illustrates a varying BER with the rotation angle θ varying between 0−π/4, provided that the ratio Eb/No for each frequency band is set to 20 dB.

As illustrated in FIG. 6, for the QPSK (denoted by “o”), the BER is minimized in the neighborhood of θ=tan⁻¹½, while, for the 16QAM (denoted by “A”), the BER is minimized in the neighborhood of θ=tan⁻¹¼.

The ratio “Eb/No” stands for a signal-to-noise ratio for digital modulation signal, where Eb is the energy per information bit and No is the noise power spectrum density.

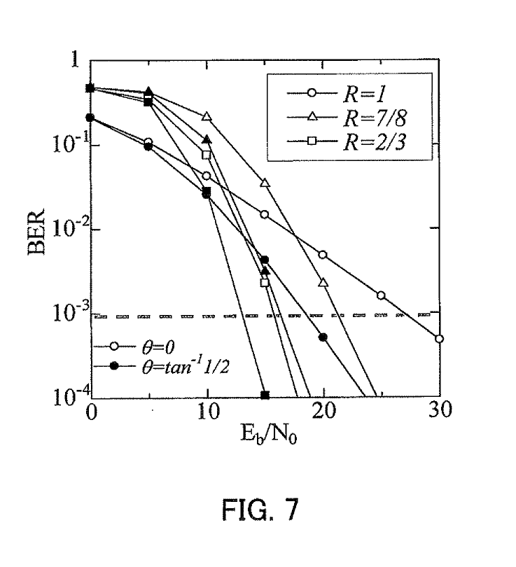

FIG. 7 is a graph of examples of BER vs. Eb/No curves for different rotation angles θ and coding rates R, provided that the QPSK is adopted and that the coding rate R and the rotation angle θ vary.

In FIG. 7, the curves denoted by corresponding symbols stand for the following conditions:

o: θ=0, R=1;

Δ: θ=0, R=⅞;

□: θ=0, R=⅔;

: θ=tan⁻¹½, R=1;

▴: θ=tan⁻¹½, R=⅞; and

▪=tan⁻¹½, R=⅔.

It is noted that, when “0=0,” the first and second transmit bit sequences are transmitted independently of each other, without being combined by the aforementioned rotation orthogonal coding.

The curves in FIG. 7 demonstrate that, whatever the coding rate R is, the BER is lower when θ=tan⁻¹½ (a minimum BER is taken, as illustrated in FIG. 6) than when θ=0.

As the coding rate R becomes lower, a frequency diversity gain obtained by the error correction becomes higher. A frequency diversity gain obtained by the pre-coding using the rotation orthogonal coding (its coding rate R is higher), becomes lower than when the coding rate R is lower.

It is noted that, in FIG. 7, for BER=10⁻³ to be achieved when Eb/No=16 dB without relaying on the rotation orthogonal coding (i.e., θ=0), the coding rate R must be ⅔.

In contrast, when θ=tan⁻¹½, the coding rate R can be set to ⅞.

As a result, achievement of BER=10⁻³ when θ=tan⁻¹½ at the same power level for receiving signals (e.g., when Eb/No=16 dB), can increase the resulting transmission capacity to a value about 1.3 (=⅞× 3/2) times as large as when θ=0. The reason is that the required BER (=10⁻³) is achieved even when the coding rate R is higher, for the frequency diversity gain obtained by the rotation orthogonal coding.

It is noted that, in the present embodiment, one transmit bit sequence is transmitted on a per-frequency-band basis (i.e., when an SISO (Single Input Single Output) is adopted), but in an alternative, a plurality of transmit bit sequences are transmitted on a per-frequency-band basis (i.e., when the MIMO is adopted). In this alternative, there are a number N (N: integer equal to or more than two) of carriers, and a number M (M: integer equal to or more than two) of transmit bit sequences are transmitted on a per-frequency-band, whereby a total number M×N of transmit bit sequences are transmitted simultaneously, using the following rotation orthogonal coding matrix C_{N,M}:

$${C}_{N , M} = ( \begin{matrix}cos θ * {E}_{M} & sin θ * {E}_{M} \\ - sin θ * {E}_{M} & cos θ * {E}_{M}\end{matrix} ) ,$$

where,

E_{M}: M×M unit matrix.

As will be evident from the foregoing, in the present embodiment, the transmitter 1 combines a plurality of initial transmit signals for carriers having distinct frequency bands, into a plurality of final transmit signals for carriers having distinct frequency bands, and transmits simultaneously these final transmit signals for spreading and multiplex transmission, resulting in an increase in a frequency diversity gain and transmission quality.

Different from the present embodiment, no one has proposed configuring a transmitter and a receiver in which spectrum aggregation is performed using the pre-coding, in particular, the rotation orthogonal coding.

Reference throughout the specification to “one embodiment” or “an embodiment” means that a particular feature, structure, or characteristic described in connection with the embodiment is included in at least one embodiment of the present invention.

Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments.

Moreover, inventive aspects lie in less than all features of a single disclosed embodiment. Thus, the claims following the Detailed Description are hereby expressly incorporated into this Detailed Description, with each claim standing on its own as a separate embodiment of this invention.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A transmitter for transmitting a plurality of transmit symbols through a plurality of transmit antennas, respectively, the transmitter comprising:
an encoder for encoding a transmit bit sequence for a plurality of carriers having respective distinct frequency bands;
a modulator for modulating each of the encoded bit sequences for the distinct carriers, to thereby generate transmit symbols;
a rotation orthogonal encoder configured to perform rotation orthogonal coding for the transmit symbols for the distinct carriers, to thereby generate a plurality of encoded transmit symbols for the distinct carriers, respectively;
a frequency-signal processor configured to perform predetermined frequency-signal processing for the encoded transmit symbol generated for each carrier; and
a transmitting block configured to transmit the plurality of encoded transmit symbols through the plurality of transmit antennas, respectively, towards a plurality of receive antennas of a receiver through which the plurality of encoded transmit symbols are received, respectively,
to thereby perform spectrum aggregation using the rotation orthogonal coding.

2. The transmitter according to claim 1, wherein the plurality of transmit antennas includes a first transmit antenna and a second transmit antenna,
a carrier number N which indicates a total number of the plurality of carriers satisfies N=2, and
the rotation orthogonal encoder is configured to perform the rotation orthogonal coding by a pre-coding technique using the following rotation orthogonal coding matrix C:
$$C = ( \begin{matrix}cos θ & sin θ \\ - sin θ & cos θ\end{matrix} ) , and ( \begin{matrix}{s}_{1}^{′} \\ {s}_{2}^{′}\end{matrix} ) = ( \begin{matrix}cos θ & sin θ \\ - sin θ & cos θ\end{matrix} ) ( \begin{matrix}{s}_{1} \\ {s}_{2}\end{matrix} ) ,$$
where,
θ: rotation angle for the rotation orthogonal coding, and
s₁: first non-encoded transmit symbol to be transmitted through first transmit antenna,
s₂: second non-encoded transmit symbol to be transmitted through second transmit antenna,
s₁′: first encoded transmit symbol to be transmitted through first transmit antenna, and
s₂′: second encoded transmit symbol to be transmitted through second transmit antenna.

3. The transmitter according to claim 1, wherein a carriernumber N which indicates a total number of the plurality of carriers satisfies N=2ⁿ (n: an integer equal to or more than two), and
the rotation orthogonal encoder is configured to perform the rotation orthogonal coding by a pre-coding technique using the following rotation orthogonal coding matrix C₂_{ⁿ}:
$${C}_{{2}^{″}} = ( \begin{matrix}{C}_{{2}^{n - 1}} cos {θ}_{n} & {C}_{{2}^{n - 1}} sin {θ}_{n} \\ - {C}_{{2}^{n - 1}} sin {θ}_{n} & {C}_{{2}^{n - 1}} cos {θ}_{n}\end{matrix} ) ,$$
where,
θₙ: rotation angle for the rotation orthogonal coding, and
C₂_{¹}: 1.

4. The transmitter according to claim 1, wherein a carrier number N which indicates a total number of the plurality of carriers satisfies N=3, and
the rotation orthogonal encoder is configured to perform the rotation orthogonal coding by a pre-coding technique using the following rotation orthogonal coding matrix C₃:
$${C}_{3} = ( \begin{matrix}cos {θ}_{1} cos {θ}_{3} - sin {θ}_{1} sin {θ}_{2} sin {θ}_{3} & cos {θ}_{2} sin {θ}_{1} & cos {θ}_{3} sin {θ}_{1} sin {θ}_{2} + cos {θ}_{2} sin {θ}_{3} \\ - cos {θ}_{3} sin {θ}_{1} - cos {θ}_{1} sin {θ}_{2} sin {θ}_{3} & cos {θ}_{1} cos {θ}_{2} & cos {θ}_{1} cos {θ}_{3} sin {θ}_{2} - sin {θ}_{1} sin {θ}_{3} \\ - cos {θ}_{2} sin {θ}_{3} & - sin {θ}_{2} & cos {θ}_{2} cos {θ}_{3}\end{matrix} ) ,$$
where,
θ₁, θ₂, θ₃: rotation angles for the rotation orthogonal coding.

5. The transmitter according to claim 1, wherein a carrier number N which indicates a total number of the plurality of carriers satisfies N=2²=4 (n=2), and
the rotation orthogonal encoder is configured to perform the rotation orthogonal coding by a pre-coding technique using the following rotation orthogonal coding matrix C₄:
$$\begin{matrix}{C}_{4} = ( \begin{matrix}{C}_{2} cos {θ}_{2} & {C}_{2} sin {θ}_{2} \\ - {C}_{2} sin {θ}_{2} & {C}_{2} cos {θ}_{2}\end{matrix} ) \\ = ( \begin{matrix}cos {θ}_{1} cos {θ}_{2} & sin {θ}_{1} cos {θ}_{2} & cos {θ}_{1} sin {θ}_{2} & sin {θ}_{1} sin {θ}_{2} \\ - sin {θ}_{1} cos {θ}_{2} & cos {θ}_{1} cos {θ}_{2} & - sin {θ}_{1} sin {θ}_{2} & cos {θ}_{1} sin {θ}_{2} \\ - cos {θ}_{1} sin {θ}_{2} & - sin {θ}_{1} sin {θ}_{2} & cos {θ}_{1} cos {θ}_{2} & sin {θ}_{1} cos {θ}_{2} \\ sin {θ}_{1} sin {θ}_{2} & - cos {θ}_{1} sin {θ}_{2} & - sin {θ}_{1} cos {θ}_{2} & cos {θ}_{1} cos {θ}_{2}\end{matrix} )\end{matrix}$$
where,
θ₁, θ₂: rotation angles for the rotation orthogonal coding.

6. The transmitter according to claim 2, wherein the rotation angle θ is selected such that signal constellation points for a modulation method that the transmitter uses are substantially uniformly spaced.

7. The transmitter according to claim 2, wherein the rotation angle θ is selected such that, if the transmitter uses QPSK (Quadrature Phase Shift Keying), 0=tan⁻¹½, and, if the transmitter uses 16QAM (Quadrature Amplitude Modulation), θ=tan⁻¹¼.

8. The transmitter according to claim 5, wherein the rotation angles θ₁ and θ₂ are selected such that, if the transmitter uses QPSK (Quadrature Phase Shift Keying), θ₁=tan⁻¹¼ and θ₂=tan⁻¹½, and, if the transmitter uses 16QAM (Quadrature Amplitude Modulation), θ₁=tan⁻¹ 1/16 and θ₂=tan⁻¹¼.

9. The transmitter according to claim 1, which is used in an LTE (Long-Term Evolution)-Advanced base station.

10. A receiver for receiving a plurality of transmit symbols which have undergone rotation orthogonal coding, through a plurality of receive antennas, respectively, the receiver comprising:
a receiving block configured to receive the plurality of transmit symbols in the form of a plurality of received carriers having respective distinct frequency bands, through the plurality of receive antennas, as a plurality of received symbols, respectively;
a signal-point information detector configured to detect a plurality of signal constellation points for use in restoring the plurality of transmit symbols, based on the plurality of received symbols, a rotation angle θ of the rotation orthogonal coding, and at least one of a channel matrix and a noise matrix; and
a transmit-symbol restorer configured to restore the plurality of transmit symbols, based on the detected signal constellation points,
to thereby perform spectrum aggregation using the rotation orthogonal coding.

11. A method of transmitting a plurality of transmit symbols through a plurality of transmit antennas, respectively, the method comprising:
encoding a transmit bit sequence for a plurality of carriers having respective distinct frequency bands;
modulating each of the encoded transmit bit sequences for the distinct carriers, to thereby generate transmit symbols;
performing rotation orthogonal coding for the transmit symbols for the distinct carriers, to thereby generate a plurality of encoded transmit symbols for the distinct carriers, respectively;
performing predetermined frequency-signal processing for the encoded transmit symbol generated for each carrier; and
transmitting the plurality of encoded transmit symbols through the plurality of transmit antennas, respectively, towards a plurality of receive antennas of a receiver through which the plurality of encoded transmit symbols are received, respectively,
to thereby perform spectrum aggregation using the rotation orthogonal coding.

12. A method of receiving a plurality of transmit symbols which have undergone rotation orthogonal coding, through a plurality of receive antennas, respectively, the method comprising:
receiving the plurality of transmit symbols in the form of a plurality of received carriers having respective distinct frequency bands, through the plurality of receive antennas, as a plurality of received symbols, respectively;
detecting a plurality of signal constellation points for use in restoring the plurality of transmit symbols, based on the plurality of received symbols, a rotation angle θ of the rotation orthogonal coding, and at least one of a channel matrix and a noise matrix; and
restoring the plurality of transmit symbols, based on the detected signal constellation points,
to thereby perform spectrum aggregation using the rotation orthogonal coding.

13. A method of transmitting a plurality of transmit signals through a plurality of transmit antennas, respectively, the method comprising:
performing a pre-coding technique in the form of rotation orthogonal coding for a plurality of transmit symbols for a plurality of carriers having respective distinct frequency bands, each of which serves a pre-encoded transmit symbol, to thereby generate a plurality of encoded transmit symbols for the distinct carriers, respectively; and
transmitting the generated encoded transmit symbols, through the plurality of transmit antennas, in the transmit signals, respectively, towards a plurality of receive antennas of a receiver through which the transmit signals are received, respectively,
to thereby perform spectrum aggregation using the rotation orthogonal coding.
